(19) United States
(12) Patent Application Publication
(10) Pub. No.: US 2013/0233464 A1
(43) Pub. Date: Sep. 12, 2013

(54) WELDING METHOD AND DEVICE FOR CARRYING OUT THE METHOD

(71) Applicant: Thomas Breuer, Konigsdorf (DE)

(72) Inventor: Thomas Breuer, Konigsdorf (DE)

(21) Appl. No.: 13/612,411

(22) Filed: Sep. 12, 2012

(30) Foreign Application Priority Data
Mar. 8, 2012 (DE) 10 2012 101 977.0

(51) Int. Cl. B32B 37/00; B32B 41/00

(52) U.S. Cl. 156/64; 156/308.2; 156/378

(57) ABSTRACT

Method for welding plastic by means of two mutually independently movable positioning units, in order to be able to move a heating element independently of a weld-on part, wherein a force sensor is provided for detecting the forces acting on the heating element and for evaluating them in order to control the movement of the units, and wherein a position detection unit, preferably arranged on a first positioning unit, provides position data regarding the connection point to the other positioning unit, in order to control its movement based thereon.

The present invention relates to a method for welding plastic parts according to claim 1, as well as a welding system and a production line according to claims 10 and 16.

Welding two plastic parts together is known in a number of variants from prior art. In automotive engineering, for example, fuel tanks are welded to filler pipes and nipples in order to be able to connect lines or hoses to the tank. The connecting point on the tank (hereinafter “body” in general) is first slightly melted (plasticized) by contact with a hot heating element. The nipple to be welded on (hereinafter “weld-on part” in general) is plasticized, preferably simultaneously and likewise by means of the heating element, in an area intended for the welded joint. After removal of the heating element or elements, the weld-on part and the body are then immediately brought into contact with one another and pressed together with a certain pressure if necessary, resulting in a stable welded joint after cooling and hardening of the plasticized area.

The devices known for this from prior art are compact heating element welding units that jointly carry the heating element and a weld-on part and can generally transport the two in a straight-line movement to the body. The heating element is first moved against the connection point on the body in order to plasticize it. The weld-on part likewise carried by the heating element welding unit can be moved against the rear part of the heating element facing away from the body in order to also be plasticized. Thereafter, the heating element is withdrawn a certain amount away from the body and the weld-on part is moved away from the rear part of the heating element in a preferably linear motion in order to allow the heating element to move out laterally between the weld-on part and the body. Then the plasticized weld-on part is moved directly to the body and is joined there to the body at the connection point previously plasticized by the heating element.

Such devices have a number of disadvantages, however. Thus, the exact alignment of the entire heating element welding unit relative to the body or the connection point is of particular importance in order to be able to uniformly and properly plasticize the connection point. Therefore, the entire unit (heating element, chuck for holding the weld-on part, tool carriage for moving the weld-on part, heating element carriage for moving the heating element, additional guides and bearings) must be suitably aligned with the connection point. Because the connection points are subject to production-induced position tolerances in large series production runs, the heating element welding units would have to be realigned for each body or each connection point. This is scarcely possible, due to the heavy unit comprising diverse components. Another problem is that the body reacts with different degrees of yielding during the plasticizing of the connecting point. The positioning of the heating element controlled only by location (target position in space) cannot take this yielding into account, so that the repeated positioning of the heating element at the connection points of successive bodies leads to different plasticization results, even if the heating element always occupies the same position in space.

This problem applies simultaneously to the weld-on part, which is pressed to varying degrees against the heating element depending on the pressing force, but this situation is not taken into account in conventional heating element welding units.

Finally, the known heating element welding units are not very flexible, because a separate welding unit is needed in each case for welding different weld-on parts to different bodies. Sometimes entire units must be replaced for different vehicle models, because the previous heating element welding unit was designed and dimensioned for welding a specific weld-on part to a specific body, i.e., was limited thereto.

The problem of the invention was therefore to offer a flexible method and suitable devices for welding plastic parts in order to, at the same time, improve the quality of the welded joint.

The problem is solved by a method according to claim 1, a welding system according to claim 10, and a production line according to claim 16.

The invention proceeds from the detection that the quality of the welded joint can be considerably improved if the plasticizing of the body at the connecting point is done by means of the heating element, taking into account the forces that result from the pressing of the heating element against the body. In the method according to the invention, the force with which the heating element presses against the connection point to the body for the plasticization is to be determined in order to react in that way to yielding of the connecting point due to the plasticization or elasticity. Thus, depending on the yielding of the body at the connection point, the heating element can be moved quickly or less quickly up to its target position or a position determined by the force evaluation. Due to the consideration according to the invention of the forces between the heating element and the body during plasticization, the movement of the heating element can be better matched to possible manufacturing tolerances with the objective of producing the connection point with reproducible accuracy of position, temperature, and plasticization degree.

The method according to the invention for welding a weld-on part to a body thus comprises at least the following steps:

a) positioning a heating element at the connection point in order to heat it,

b) positioning the weld-on part at the heated connection point in order to produce the weld, and

c) positioning the heating element while taking into account the forces that result from the pressure of the heating element against the body.

Typically, the weld-on part is also heated or plasticized before being joined to the body. In the prior art (heating element welding unit), this has been done by contacting the weld-on part with the same heating element (at its rear side, for example) with which the plasticization of the body at the connecting point is also produced. This procedure is in principle also conceivable for the method according to the invention, so long as a possible influence on the forces between the heating element and the connection point is taken into account. It has proven to be an expedient alternative, however, if the weld-on part is heated and plasticized with a heating device separate from the above-mentioned heating element. Thereby overlapping forces at the (otherwise single) heating element and the resulting influences on the quality of the plasticization at the connecting point can be avoided with certainty.

In a refinement of the method according to the invention, one embodiment provides that the weld-on part is positioned at the connection point of the body, taking into account the forces that result from the pressing of the weld-on part against the body. Analogously to the discussions above, the quality of the welded joint also depends on the forces that occur between the body and the weld-on part during the joining of the two components. Without taking into account these joining forces, the weld-on part is always brought into a predetermined spatial position on the body with the assumption that the weld-on part has the ideal contact with the plasticized connection point there in order to form an optimal weld joint. Depending on the degree of plasticization of the connection point and the weld-on part at the moment of joining, it can be expedient, however, to press the two components against one another with a smaller or larger force, or it may turn out, after evaluation of the forces and the current position data of the weld-on part, that a proper welded joint cannot be produced or was not produced. Thus the monitoring of the forces at the heating element, in connection with the monitoring of the forces on the weld-on part, serves to form an especially high-quality welded joint.

The “forces” detected should also be understood to mean torques that occur at the heating element or at the weld-on part during plasticization of the connecting point or during joining and likewise are to be taken into account according to the invention. For example, a weld-on part could be inadvertently plasticized on only one side of a circular plasticization area, or at least non-uniformly over the periphery. During joining it is easier to penetrate into the connection point that has the more strongly plasticized area, so that the weld-on part or a chuck holding it thereby undergoes a bending torque. By taking into account this bending torque, the movement and/or orientation of the weld-on part can be immediately corrected in accordance with the invention. A reliable determination of the quality of the welded joint can be made by evaluating the data occurring during the joining process and/or otherwise measurable (temperature, joining time, joining or feeding speed, position of the weld-on parts, joining forces and torques) based on definable evaluation criteria.

Of course it is possible to take the forces at the welding element into account not only during the joining process; this can also be done during the preceding plasticization of the weld-on part at the heating element or a separate heating device, in order to achieve an improved plasticization result, independently of production, positioning, or melting temperature tolerances.

An especially advantageous and flexible form of the method according to the invention is implemented if the heating element can be held and moved by means of a first positioning unit and the weld-on part by means of a second positioning unit movable independently of the first positioning unit. The following advantages in comparison to the previously known methods are achieved with this measure.

Firstly, the movement of the weld-on part is no longer coupled to the movement of the heating element, as is the case in conventional heating element welding units. Instead, the weld-on part can be moved independently of the heating element freely in space, whereby the quality of the welding joint is further improved, as will be seen below.

In the prior art, the movements of the heating element and the weld-on part were dependent upon one another due to the mechanical coupling (common heating element welding unit), and in terms of time as well. The separate movability of the weld-on part and heating element provided in accordance with the invention allows, in particular, time-optimized coordination of the individual movements. For example, the just-plasticized weld-on part can already be moved freely in space in the direction of the connection point while the latter is still being plasticized by the heating element. At the same time, it can be ensured that the heating element is removed from the connecting point at the right time so that it does not collide with the approaching weld-on part. The latter can then be inserted into the just-plasticized connecting point while the heating mirror is being moved back into a starting position. This saves production time and largely prevents unwanted cooling of the plasticized areas before joining.

Another significant advantage of the separate movements of the weld-on part and heating element is that the above-described forces can be detected and processed completely independently of one another for the weld-on part and the heating element if each of the two positioning units has the above-described means for detecting the forces. The problem of force superposition at the heating element (for example, by plasticizing contact with the body and the weld-on part to be plasticized at the rear on the heating element) can be prevented in this way.

Another special advantage of the separate movement guidance of the weld-on part and heating element is seen according to a further improved variant of the method. This provides that the position of the body contour at the connecting point is detected and evaluated by a position detection system before the positioning of the heating element on the body. The background of this variant is the fact that, as a result of production or due to clamping errors, the connecting points of individual bodies often deviate from an ideal position and, for example, may be slanted several degrees in space relative to the ideal position. If this position deviation is not taken into account, the heating element will not lie flush during the automated process, but instead will be placed slightly tilted on the connecting point, corresponding to the deviation and resulting in an asymmetrical and non-uniform plasticization. The monitoring of the pressing forces according to the invention does allow a correction of the movements and orientation of the heating element, but it can take effect only during the plasticizing process. The position detection, on the other hand, is intended to detect the actual position of the connecting point on the body or in space in order to adjust the orientation of the heating element to this actual position, even before the beginning of the plasticization of the connecting point. This ensures that the heating element will always be placed or pressed at an optimal orientation or flush against the connection point to be plasticized, in order to guarantee an optimally uniform plasticization, even for connection points deviating from one another in orientation.

The position detection system can expediently be arranged on the positioning unit that supports and moves the heating element, so that the position determination of the connecting point can already be determined during the approach movement of the heating element to the connection point. Then the position data in the relevant positioning unit or a higher-level controller can lead to a coordinated adaptation of the orientation and movement of the heating element.

In addition to recognizing the position of the body contour at the connection point, the positioning system (or an additionally provided component) can also recognize the body itself. For a given type of body (e.g., type K₁), the number or position and type of the weld-on parts to be attached can be immediately determined from an assignment table stored in a database or control unit. If the position detection unit encounters a body of type K₂, for example, then correspondingly different specifications for the selection and positioning of the weld-on parts apply. Every type of marking that can be read by the position detection system is suitable for marking the body. It is even conceivable to use the shape of the body itself as the characteristic marking feature, so that separate marking, by means of a barcode for example, can be eliminated.

The special advantage of the positioning units provided separately for the weld-on part and the heating element is that the actual data for the connecting point detected by the position detection system (or also the positioning data of the heating element during the plasticization process at the connection point dependent on said actual data) can be transmitted to the second positioning unit in order to advance the weld-on part moved by the unit to the connection point correctly and possibly with a corrected position (the weld-on part mechanically coupled to the heating element according to prior art would likewise follow the correction motion of the heating element, but the system would lose the possibility of separate force monitoring and especially the flexibility with respect to different weld-on parts—see below). The force monitoring provided respectively for the weld-on part and the heating element, with separate movability and in connection with the position detection of the connection point, offers all means necessary for a welding method that is extraordinarily flexible and, at the same time, fast and accurate.

The method according to the invention allows another advantageous method step for preparing the welding process, which [step] brings about considerable savings of time. Before a connection point is plasticized at all, the retaining device for holding the weld-on part arranged on the second positioning unit is first moved in a targeted manner to the location of the intended connection point in this step, in order to store the position it occupies in space as a “target position” in the control unit and to base the further movements of the positioning units thereon. In this manner, it is possible to detect or determine relatively easily the spatial position of the holding device relative to the connection point, which would otherwise have to be done by separate determination/measurement of the position of the body or of its connection point relative to the positioning unit or the holding device it carries, and inputting this data into a control unit. Instead, the above method step provides for advancing or moving the holding device to the position of the connection point, the position assumed by the holding device then being defined “at the push of a button” as the target position to be approached by the heating element or the weld-on part in the further process. To do this, the individual axes of the positioning unit are detected by associated position sensors or are read out from the controller of the positioning unit and stored in an associated control unit whenever the holding device has assumed its target position.

On the one hand, it would be possible to move the holding device into the target position by driving the individual axes of the positioning unit for advancement and checking the respective result visually. This could be done, for example, with the aid of a manually operated joystick that is actively connected to a higher level control unit or the positioning unit in such a manner that the movements of the joystick lead to spatial movements of the retaining device carried by the positioning unit on its final axis. In this way, the operator can observe the forced movements of the retaining device or can control them with the aid of the joystick so that the retaining device ultimately occupies the desired target position on the body. The movement of the positioning unit is thus controlled here by inputting signals from a joystick or from a keyboard, etc., which are converted into drive signals for the individual axes of the positioning unit.

As an alternative, a particularly advantageous method for positioning the retaining device uses the force sensors provided on the positioning unit. The sensors which—as described—can detect the forces acting on the weld-on part or the associated retaining device and supply them to a higher-level control unit are used in this alternative variant of the method for “inputting” the desired traversing movement. In a special positioning mode (“teach in”), the positioning unit can also be moved by the operator lifting and pulling or, if necessary, swiveling the retaining device arranged thereon into the target position. The positioning unit follows the manual “commands” acting thereon, which it receives in the form of signals from the force sensors and which are converted by a higher-level control unit into suitable control signals for the axes of the positioning unit. For example, the operator would apply normal or bending forces to one or more force sensors by means of a horizontally exerted tensile force. The signals transmitted automatically by the sensors to the control unit are converted by the latter into control commands for the axes of the positioning unit in such a manner that the input forces are reduced by virtue of the fact that the retaining unit follows the movement direction manually specified by the operator. A predetermined connection point on the body can be approached or defined in this manner very quickly and, above all, practically. The (sometimes slight) change of position of a connecting point, as frequently occurs during prototype construction, can be easily undertaken in this manner, with manual positioning or displacement possible even in the millimeter range with a suitable sensitivity of the force sensors.

The positioning unit along with the weld-on part it carries can subsequently “automatically” approach with the position data input or stored in this manner. The positioning unit bearing the heating element can also access this data according to the invention and can use it for positioning the heating element at the connecting point, for example.

During the joining at the plasticized connection point of the body, the weld-on part is expediently positioned, taking into account the correction data determined based on a spatial position of the heating element while plasticizing the connection point or of the contour of the body at the connection point before or after plasticizing. Thus, the weld-on part can be oriented starting from the originally determined actual position of the connection point, or the basis can be the position of the heating element occupied during the plasticizing of the connection point or immediately before removal of the heating element from the connection point. In the latter case, it is advantageously possible to take account of the fact that the surface of the connection point can be deformed to a slight degree by the plasticization with respect to the position determined by the detection system before plasticization. The final position of the heating element directly before termination of plasticization possibly provides the most accurate data regarding the position of the plasticized connection point for the subsequent positioning of the weld-on part. It goes without saying that formation of the average value and tolerances in a control unit at any time during the welding process is conceivable in order to optimize the positioning of the weld-on part and the heating element relative to the position of the connection point.

A particularly preferred embodiment of the method according to the invention accordingly comprises the following process steps:

i) detecting the position of the contour of the body (K) at the connection point (V) by a position detection system (D);

ii) positioning the heating element (H) at the connection point (V) by means of a first positioning unit (P₁), adapting to the spatial orientation of the heating element based on the detected contour at the connection point (V);

iii) detecting the force exerted by the body (K) onto the heating element (H) and controlling the further movement of the heating element (H) based on this force, in order to achieve a sufficiently heated and plasticized connection point (V) at a specifiable position on the body (K);

iv) removing the heating element (H) from the connection point (V) and positioning the weld-on part (S) at the connection point (V) by means of a second positioning unit (P₂), taking into account the previously determined position data of the connection point (V), and

v) detecting the force exerted by the body (K) onto the weld-on part (S) and controlling the further movement of the weld-on part (S) in order to create the welded joint based on this force, the weld-on part (S) having been plasticized at a separate heating device before step iv).

A welding system for carrying out the method according to the invention comprises a first positioning unit for holding and positioning at least one heating element in order to heat or slightly melt (plasticize) the connection point with the heating element. Additionally, a second positioning unit, movable independently of the first positioning unit, is provided to hold and position at least one weld-on part. In particular, the positioning units can be 5-axis or 6-axis robots that are configured to receive the weld-on part or the heating element by means of respective suitable retaining devices (collet chucks, for example).

The welding system according to the invention further comprises a force sensor for determining forces that act on the heating element and that result in particular from its contact with the body, so that the data obtained with the force sensor can be taken into account in the positioning of the heating element. The force sensor provided at least for the heating element is preferably seated on the robot axis that directly bears the heating element. In this way, influences from other forces such as weight forces of downstream robot axes can be avoided.

The welding system according to the invention expediently also comprises a force sensor seated on a second positioning unit in order to detect the forces acting on the weld-on part. Of particular interest in this regard—as already mentioned for the method—are the joining forces when inserting the weld-on part into the connection point, or the pressing forces against the heating element or a separate heating device that occur during plasticization.

The first and second positioning units can be two robots of similar structure, the first positioning unit being constructed to accommodate the heating element, while the second positioning unit can comprise one or more collet chucks in order to be able to grip the weld-on part.

According to another advantageous embodiment of the welding system, it comprises a position detection system that is preferably arranged on the first positioning unit. The position detection system is intended to detect the position of the body contour at the connection point and to evaluate it or to transfer the detected data to a higher-level controller for evaluation, in order to optimally orient the heating element for heating or plasticizing the connection point based on the detected contour. The position detection system can in principle also be arranged detached from the two positioning units on a separate construction and can be movable if desired in order to also be able to individually detect different connection points at different positions for different bodies. It is expedient, however, for the position detection system to be movable jointly with the heating element, since thereby an additional retaining device is unnecessary, and in any case the heating element (and thus at least part of the first positioning unit) must be moved towards the connection point for plasticizing, which likewise applies to the position detection system. The position detection can preferably be done optically, by laser-assisted scanning of the body or the connection point, for example. Known image detection methods can also be used for this purpose.

The advantageous distribution of the weld-on part and the heating element onto two separate positioning units is particularly advisable for a further-developed welding system. In this case, the first positioning unit is to be constructed according to the invention with several heating elements in order to be able to plasticize the body with different heating elements. This can be considered for connection points of different designs on one body, which would require the use of appropriately differently shaped heating elements. It can also make sense for maintenance or exchange purposes to provide several heating elements simultaneously for the first positioning unit. For example a star-shaped arrangement on the fifth or sixth axis of a robot can be considered. Each of the individual heating elements can then be selectively moved for plasticizing the connection points on the body, while the other heating elements are carried along, heated or unheated. A changing device for receiving different heating elements from a heating element magazine is also conceivable, in which case warm-up times in case of a change of heating elements must be taken into account. Alternatively, the heating elements present in the magazine can be heated continuously by supplying energy.

Alternatively or additionally, a welding system according to the invention provides that the second positioning unit is also formed to accommodate several—preferably different—weld-on parts in order to selectively position them at different connection points of the body. This results in a wide variety of usage possibilities for the welding system, even for different bodies and different weld-on parts.

Two different nipples as weld-on parts can be attached at two different connection points to a first body in the form of a type A vehicle fuel tank by having a first heating element appropriately plasticize the first connection point, after which the second positioning element inserts a provided and likewise plasticized weld-on part. This second connection point can then be plasticized with the same or possibly a changed heating element, while the second positioning unit removes a further (different) weld-on part from a weld-on part magazine for plasticization at a separate heating device and finally joins it to the tank at the second connection point.

The same welding system could then provide a differently shaped type B fuel tank, again with different or identical welding parts at three different connection points, by picking up the necessary heating elements and welded parts from respective available magazines with the individual positioning units and using or inserting them, respectively. In contrast to the prior art, in which a heating element welding unit was essentially limited to one heating element, one body type and one weld-on part, the system according to the invention allows particularly flexible welding of a wide variety of weld-on parts to different bodies at different connection points.

Based on the above-described method or the above-described welding system, the flexibility for welding plastic parts is further increased in a production line with several welding systems of the type mentioned above. The individual systems can be arranged in series or in parallel and supplied with identical or different bodies by at least one feed unit. Each welding system can then execute the welding tasks matched to the respective provided body by creating the desired welded joints at the different provided connection points of the body by selecting the suitable heating element and the desired weld-on part. The production line can provide several welding systems simultaneously with identical bodies, each system performing essentially the same welding.

It is also conceivable, however, that each individual system can be used, i.e., can weld, on identical bodies at respectively different connection points. Thus welding system 1 could weld at a connection point 1, welding system 2 at connection points 2 and 3 and a third welding system 3 could weld at connection points 4 and 5. However, different bodies can also be furnished with all required welded joints on individual or multiple welding systems, i.e., all connections for the type A body at welding system 1, all welded joints for the type B body with welding system 2 and all welded joints for the type C body with welding system 3. The welds for each body can also be distributed onto two or more welding systems.

It is clear that a wide variety of combinations of welded parts, heating elements and bodies to be welded can be produced if desired with the assistance of such a production line, without the end of series production for a given model leading to disposal of a welding system, because according to the invention it is not matched to a specific model.

An embodiment of the invention will be described below with reference to the figures. Therein:

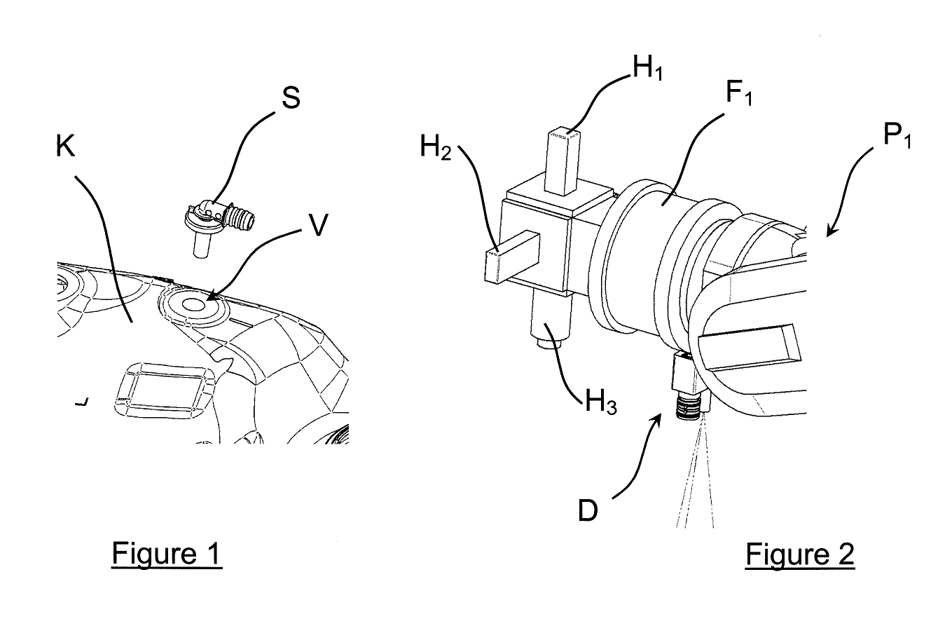

FIG. 1 shows a partial view of a body with a weld-on part to be welded thereon;

FIG. 2 shows a partial view of a first positioning unit with several heating elements supported thereon;

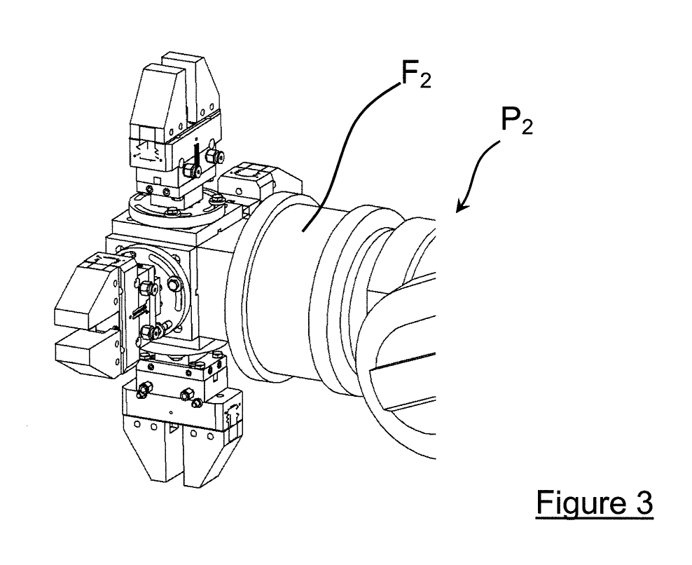

FIG. 3 shows the front section of a second positioning unit with several collet chucks for the weld-on parts, and

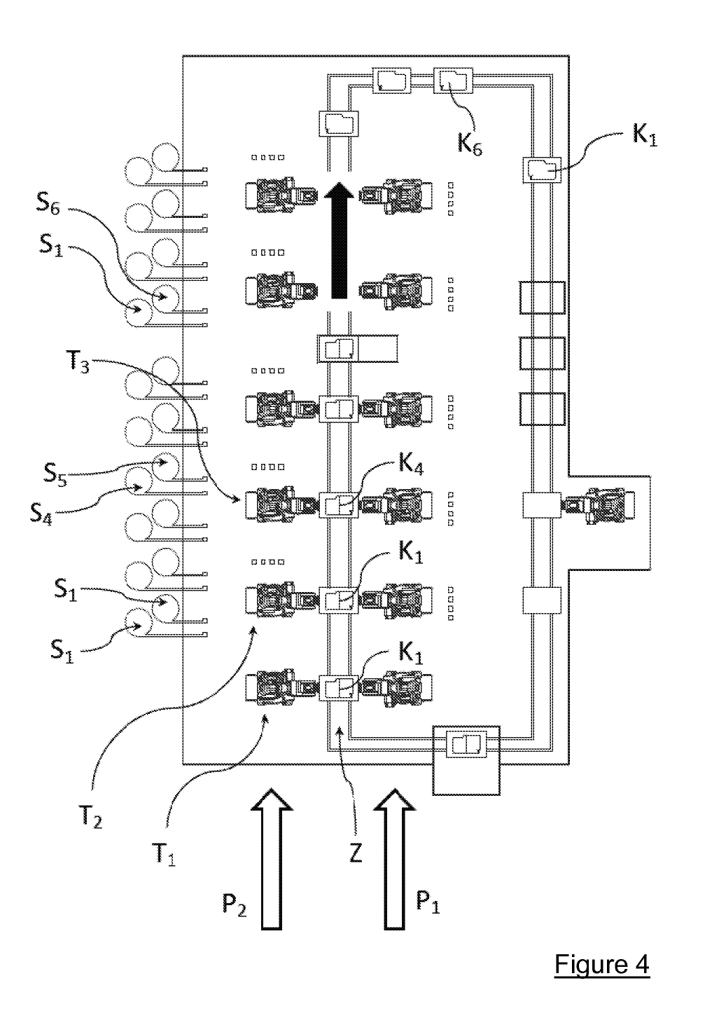

FIG. 4 shows a schematic representation of a production line with several welding systems.

FIG. 1 shows a cutaway section of a plastic tank as the body (K), to which a nipple functioning as a weld-on part (S) is to be welded at a connection point (V). Connection lines can be connected to the weld-on part. A high-quality welded joint is essential for the fuel tank illustrated here.

Part of a first positioning unit (P₁) can be seen in FIG. 2. The first positioning unit P₁ is a robot supporting several heating elements (H₁, H₂, H₃) arranged in a star shape on its final axis. The heating elements (H₁, H₂, H₃) are mounted on a common support, which is in turn supported by a first force sensor (F₁). Forces acting on the heating elements are detected by the first force sensor (F₁) and transferred to a higher-level control unit, not shown, for evaluation.

A position detection system (D), which is likewise supported by the first positioning unit (P₁), is arranged adjacent to the first force sensor (F₁). It is used to detect surface contours of the body (K), in order to be able to generate the correct orientation of the heating elements. For that purpose, the first positioning system (P₁) can be moved over the body (K) shown in FIG. 1 in such a manner that the position detection system (D) can detect the position and spatial orientation (location) of the connecting point (V) and report it to a higher-level control unit, not shown, for evaluation. Depending on the evaluated data, the first positioning unit (P₁) can position the heating element (H₃), for example, at an optimally adapted inclination on the connection point (V), in order to heat and plasticize it. The weld-on part (S) shown in FIG. 1 is outside the movement path of the first positioning unit (P₁).

During the plasticization process, the contact forces between the heating element (H₃) and the connection point (V) that are picked up by the first force sensor (F₁) can likewise be evaluated and taken into account for further controlling the movement of the heating element (H₃) in order to place an optimal load on or plasticize the connection point (V).

After the connection point (V) has been partially melted or plasticized, the arm of the first positioning unit P₁ with the heating element (H₃) shown in FIG. 2 is moved away from the connection point (V) in order to allow the joining of the weld-on part (S).

A second positioning unit (P₂), which can likewise be a robot, is shown in FIG. 3. On the arm shown, the second positioning unit (P₂) bears a mount provided with several collet chucks, each collet chuck being constructed to temporarily hold a weld-on part (S) not shown in detail in FIG. 3. The mount with the collet chucks is supported by a second force sensor (F₂) that, analogously to the version on the first positioning unit (P₁), signals the forces acting on the collet chucks or weld-on parts to a higher-order controller in order to be able to carry out the movement of the weld-on part while taking those forces into account.

Following the above-described plasticization of the connection point (V) on the body (K), a weld-on part S held by a collet chuck can be inserted by the second positioning unit (P₂) into the connection point (V) illustrated in FIG. 1. The positioning takes into account the location data for the connection point obtained by the position detection system (D) and the data transferred from the second force sensor (S₂), in order to insert the weld-on part (S) with the optimum force or speed into the target position at the connection point (V). The first positioning unit (P₁) can be moved independently of the second positioning unit (P₂), with a shared higher-level controller precluding the collision of the two units.

In a schematic plan view, FIG. 4 shows a production line with several welding systems (T₁, T₂, T₃ . . . ). The welding systems are arranged alongside a feeder (Z) in a production building, the second positioning units (P₂) of each welding system T being situated to the left of the feeder (Z), whereas the respective first positioning units (P₁) are located on the opposing right side of the feeder (Z).

Near the respective second positioning units (P₂), there are magazines for the individual welding systems (T₁, T₂, T₃ . . . ) in which respective different weld-on parts (S₁, S₂, S₃ . . . ) are kept available (not all systems, weld-on parts and bodies are labeled in FIG. 4). Magazines, not labeled in detail, from which the first positioning units can each grasp and use different heating elements, are also present at the side of the respective first positioning units.

Identical or different bodies (K₁, K₂ . . . ) can be supplied to the individual welding systems (T₁, T₂, T₃ . . . ) with the feeder (Z), in order to perform a wide variety of welding tasks. Thus the first two welding units (T₁ and T₂) are used, for instance, to apply a first weld-on part (S₁) to a body (K₁). The third welding unit (T₃), on the other hand, joins two weld-on parts (S₄ and S₅) to a body (K₄) different from the body K₁. The fifth welding system, not labeled, keeps weld-on parts (S₁) and (S₆) available, in order to selectively equip bodies (K₁) or (K₆), for example.

In principle, each welding system in this production line can arrange different weld-on parts on different bodies using different heating elements and is not fixed to a specific type of body or a specific welded joint. The production line and the welding systems deployed therein are therefore also usable for different or successive generations of vehicles or tanks thereof without significant retooling. The new acquisition of individually designed heating element welding units for each new welding task, as was common in the prior art, can now be dispensed with.

1. Method for welding plastic parts with which a weld-on part (S) is to be welded onto the contour of a connection point (V) of a body (K), the method comprising the following steps:
a) positioning a heating element (H) at the connection point (V) in order to heat it,
b) positioning the weld-on part (S) at the heated connection point (V) in order to produce the weld,
characterized in that
c) the positioning of the heating element (H) takes into account the forces that result from the pressure of the heating element (H) against the body (K).

2. Method according to claim 1, characterized in that the weld-on part (S) is likewise heated before its positioning according to b), the heating likewise taking place by positioning the weld-on part (S) with its area to be heated
i) on the heating element (H) or
ii) on a separate heating device.

3. Method according to claim 1 or 2, characterized in that the weld-on part (S) is positioned at the connection point (V) taking into account those forces that result from the pressing of the weld-on part (S) against the body (K).

4. Method according to claim 1 or 2, characterized in that the heating element (H) can be held and moved by means of a first positioning unit (P₁) and the weld-on part (S) can be held and moved by a second positioning unit (P₂) that is movable independently of the positioning unit (P₁).

5. Method according to the preceding claim, characterized in that, before the positioning of the heating element (H) in accordance with process step a) of claim 1, a holding device provided on the positioning unit (P₂) for temporarily accommodating the weld-on part (S) is moved—preferably manually—into a target position in which it defines the position of the connection point.

6. Method according to one of the preceding claims, characterized in that each of the two positioning units (P₁, P₂) comprises means for detecting forces acting upon a component carried by them, in particular a heating element (H) or a weld-on part (S₁, S₂ . . . ), these forces being taken into consideration in the positioning of the component on the body (K).

7. Method according to one of the preceding claims, characterized in that, before positioning of the heating element (H) in accordance with process step a), the position of the contour of the body (K) at the connection point (V) is detected and evaluated by a position detection system (D) in order to orient the heating element (H) for the method step a) based on the detected contour in space.

8. Method according to one of the preceding claims, characterized in that the positioning of the weld-on part (S) in accordance with method step b) takes into account correction data determined based
i) on a spatial position of the heating element (H₁) during method step a) or
ii) on the spatial position of the contour of the body (K) at the connection point (V) before or after method step a).

9. Method according to one of the preceding claims, characterized in that a control unit controls the movements of the heating element (H) or the weld-on part (S) based on the data supplied by the control unit, the data relating to
i) the position of the contour of the body (K) at the connection point (V) and/or
ii) a position of the heating element (H) during method step a) and/or
iii) resulting forces at the weld-on part or the heating element and/or
iv) the time, the speeds, the path traveled, or the position of the weld-on part or the heating element.

10. Method according to one of the preceding claims, comprising the following method steps:
i) detecting the position of the contour of the body (K) at the connection point (V) by a position detection system (D);
ii) positioning the heating element (H) at the connection point (V) by means of a first positioning unit (P₁), adapting to the spatial orientation of the heating element based on the detected contour at the connection point (V);
iii) detecting the force exerted by the body (K) onto the heating element (H) and controlling the further movement of the heating element (H) based on this force in order to achieve a sufficiently heated and plasticized connection point (V) at a specifiable position on the body (K);
iv) removing the heating element (H) from the connection point (V) and positioning the weld-on part (S) at the connection point (V) by means of a second positioning unit (P₂), taking into account the previously determined position data of the connection point (V), and
v) detecting the force exerted by the body (K) onto the weld-on part (S) and controlling the further movement of the weld-on part (S) in order to create the welded joint based on this force,
wherein the weld-on part (S) is plasticized before step iv) at a separate heating device.

11. Welding system (T) for welding plastic parts, in particular according to one of the preceding methods, in order thereby to weld a weld-on part (S) to the contour of a connection point (V) of a body (K), the welding system comprising
a) a first positioning unit (P₁) for holding and positioning at least one heating element (H) in order to heat the connection point (V) with the heating element (H),
b) a second positioning unit (P₂) movable independently of the first positioning unit (P₁), for holding and positioning at least one weld-on part (S),
characterized in that
c) the welding system comprises a force sensor (F₁) for detecting forces acting on the heating element (H) and resulting in particular from its contact with the body (K), in order to be able to take into account the data detected with the force sensor (F₁) during the positioning of the heating element (H).

12. Welding system (T) according to the preceding system claim, characterized in that the second positioning unit (P₂) comprises a force sensor (F₂) for detecting forces that act on the weld-on part (S) held by the second positioning unit (P₂) in order to be able to take the data detected with the force sensor (F₂) into account in the positioning of the weld-on part (S).

13. Welding system (T) according to one of the preceding system claims, characterized in that the welding system comprises a position detection system (D), preferably arranged on the first positioning unit (P₁), with which the position of the contour of the body (K) at the connection point (V) can be detected and evaluated in order to orient the heating element (H) in space for heating the connection point (V) based on the detected contour.

14. Welding system (T) according to one of the preceding system claims, characterized in that
i) the first positioning unit (P₁) is constructed to hold several heating elements (H₁, H₂, H₃ . . . ) in order to be able to position them selectively at different connection points (V), and/or
iii) in that the second positioning unit (P₂) is constructed to hold several, preferably different, weld-on parts (S₁, S₂, S₃ . . . ) in order to position them selectively at different connection points (V₁, V₂, V₃ . . . ) of the body (K).

15. Welding system (T) according to one of the preceding system claims, characterized in that the two positioning units (P₁, P₂) directly or indirectly exchange signals with one another or with a control unit, in order to be able to control the movements of heating element (H) and weld-on part (S) based on data of the respective other positioning unit (P₁, P₂), from force sensors (F₁, F₂) or from a position detection system (D).

16. Welding system (T) according to one of the preceding system claims, characterized in that a heating device separate from the heating element (H) is provided in order to heat an area of the weld-on part (S) by positioning it at the separate heating device by means of the second positioning unit (P₂).

17. Production line with several welding systems (Tₐ, T_{b}, T_{c} . . . ) according to one of the preceding claims, with a feeder (Z), for supplying the individual welding systems (Tₐ, T_{b}, T_{c} . . . ) with identical or different bodies (K₁, K₂, K₃ . . . ) in order to weld different or identical weld-on parts (S₁, S₂, S₃ . . . ) simultaneously or successively on different welding systems (Tₐ, T_{b}, T_{c} . . . ) onto identical or different connection points (V₁, V₂, V₃ . . . ) of the bodies (K₁, K₂, K₃ . . . ).
